(19) United States
(12) Patent Application Publication
(10) Pub. No.: US 2014/0180457 A1
(43) Pub. Date: Jun. 26, 2014

(54) ELECTRONIC DEVICE TO ALIGN AUDIO FLOW

(71) Applicants: Anshuman Thakur, Beaverton, OR (US); Michael N. Derr, El Dorado Hills, CA (US); Hema Tahilramani, Santa Clara, CA (US); Andrzej Mialkowski, Gdansk (PL)

(72) Inventors: Anshuman Thakur, Beaverton, OR (US); Michael N. Derr, El Dorado Hills, CA (US); Hema Tahilramani, Santa Clara, CA (US); Andrzej Mialkowski, Gdansk (PL)

(21) Appl. No.: 13/727,410

(22) Filed: Dec. 26, 2012

(51) Int. Cl. G06F 17/00

(52) U.S. Cl. CPC G06F 17/00
USPC 700/94

(57) ABSTRACT

An electronic device is provided that includes an input device to provide first audio signals, an output device to receive second audio signals, and logic to receive the first audio signals and to provide an audio input flow. The logic to further receive an audio output flow and to provide the second audio signals to the output device based on the audio output flow. The audio device to further align the audio input flow relative to the audio output flow.

### BACKGROUND

1. Field

An embodiment may relate to adjusting an audio flow of an electronic device.

2. Background

The running of a processor of an electronic device (or a mobile computing system) may drain battery power. Electronic devices may therefore attempt to conserve power by switching the processor into various low power/idle states when there are no instructions to be executed. The processor may be awakened to perform various operations. There is a power cost associated with the processor awakening and going into a sleep mode. Energy may be wasted in transitioning between a sleep mode and an active mode.

### BRIEF DESCRIPTION OF THE DRAWINGS

Arrangements and embodiments may be described in detail with reference to the following drawings in which like reference numerals refer to like elements and wherein:

FIG. 1 shows audio input/output paths and audio input/output threads;

FIG. 2 shows an electronic device having audio paths according to an example embodiment; and

FIGS. 3A-3B are flowcharts showing alignment of an audio input flow and an audio output flow according to an example embodiment.

### DETAILED DESCRIPTION

Arrangements and embodiments may relate to an electronic device having an audio system that includes an audio input flow (or path) and an audio output flow (or path). The electronic device may be a mobile phone, a smart phone, a personal digital assistant, a media player, a laptop computer, a notebook computer, a personal computer, a tablet, etc.

The audio input flow of the electronic device may be from an input device such as a microphone, for example. The audio output flow of the electronic device may be provided to an output device, such as a speaker or a headphone, for example.

Usage of the input device may activate the audio input flow. Usage of the output device may activate the audio output flow. The input device may also be called an audio input device. The output device may also be called an audio output device.

The electronic device may have a communication application (such as a voice communication) that may utilize both the audio input flow and the audio output flow. However, the audio input flow and the audio output flow may not be processed with each other, and thus the audio input flow and the audio output flow may operate asynchronously with respect to each other.

The audio input flow may provide interrupts to a host processor. The audio output flow may also provide interrupts to the host processor. However, the asynchronous execution of the audio input flow and the audio output flow may result in each audio flow separately providing interrupts to the host processor. This may cause the host processor to separately service each interrupt at a different time. This may utilize excessive time and power of the processor. This may decrease battery life when the processor is awakened from a sleep mode and/or an idle mode.

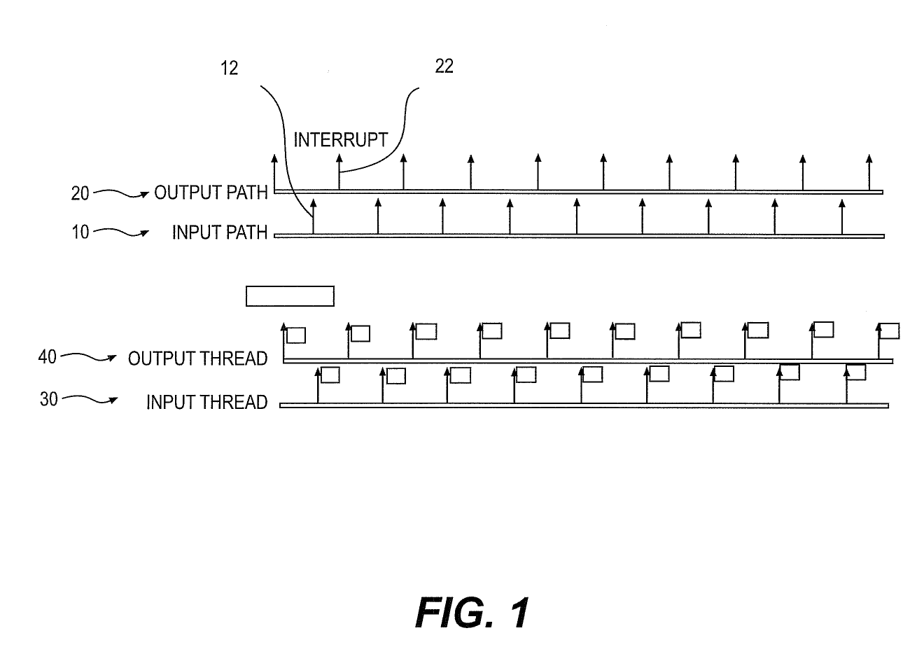

FIG. 1 shows audio input/output flows and audio input/output threads according to an example arrangement. Other arrangements may also be provided.

More specifically, FIG. 1 shows an audio input flow 10 having interrupts 12 at a periodic rate over a period of time. FIG. 1 also shows an audio output flow 20 having interrupts 22 at a periodic rate over a period of time. The audio input flow 10 may be from the input device (of the electronic device). The audio output flow 20 may be created based on an output of the output device (of the electronic device). As shown in FIG. 1, the interrupts 12 (of the audio input flow 10) are not synchronous with the interrupts 22 (of the audio output flow 20). That is, the interrupts 12 from the audio input flow 10 are not aligned with the interrupts 22 from the audio output flow 20.

The interrupts 12, 22 may be provided to a processor to perform various operations based on the received interrupts. However, in systems that include power management, the processor may be transitioned in a sleep mode (or an idle mode). In the sleep mode, the processor may not be in full use and/or may be shut down (or portions may be powered down). When the processor receives an interrupt from a data flow (such as an audio flow), then the processor may be awaken (i.e., turned on or other portions powered on) so as to perform an operation related to the interrupt. After performing the necessary operation, the processor may return to the sleep mode (or idle mode).

An output interrupt (related to a speaker directed audio flow) may indicate that an audio buffer has been rendered on the output device, and the buffer is provided back to the operating system for reuse.

On the input path, the host processor may take the audio sample, perform an audio enhancement (such as echo cancellation and noise reduction) and then perform encoding. The encoding may be a compression of audio to transmit to another electronic device.

FIG. 1 also shows an audio input thread 30 related to the processor execution of the audio input flow 10. FIG. 1 also shows an audio output thread 40 related to the processor execution of the audio output flow 20. Since the processor is awakened by the received interrupts 12, 22, the processor may operate often.

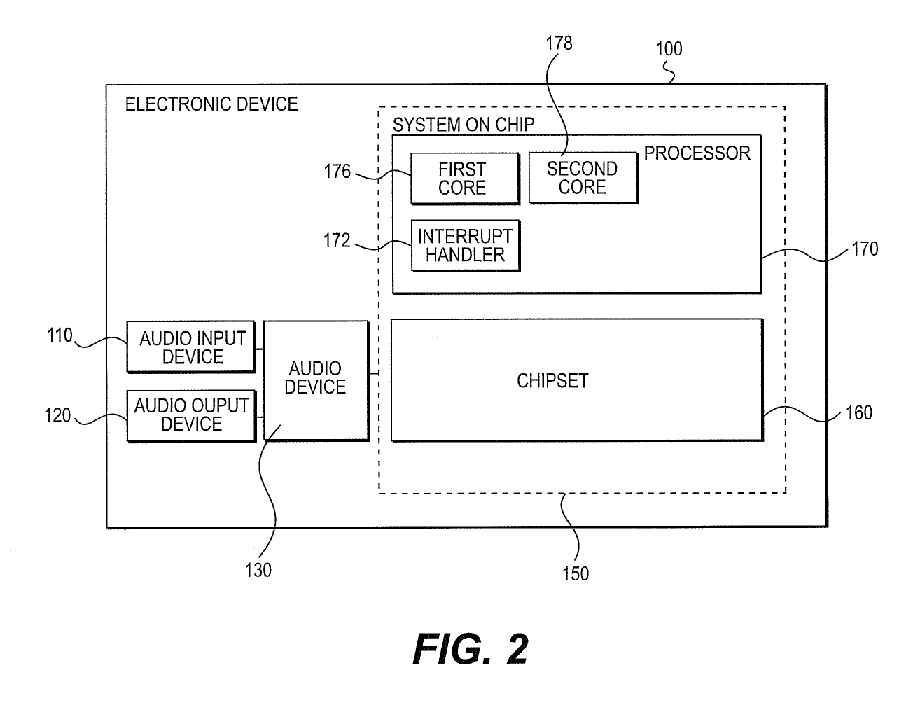

FIG. 2 shows an electronic device having audio flows (or audio paths) according to an example embodiment. Other embodiments and configurations may also be provided.

FIG. 2 shows an electronic device 100 that includes an audio input device 110, an audio output device 120, an audio device 130 and a system on chip 150 (or SoC). The audio input device 110 may provide the audio input flow (or audio input path). The audio input device 110 may be a microphone, for example. The audio output device 120 may be a speaker (or headphone port).

The audio input device 110 and the audio output device 120 may be electrically coupled to the audio device 130. On the input side, the audio device 130 may take samples from the audio input device 110 (such as a microphone), convert the samples into analog to digital samples, and enhance quality of the sample. On the output side, the audio device 130 may convert digital data to analog signals and drive the audio output device 120 (such as speakers or headphones) to render audio (i.e., voice and/or music).

The audio device 130 may be electrically coupled to the system on chip 150 (or other device). The system on chip 150 may include a chipset 160 and a processor 170, for example. Other components such as memory and/or drivers may also be provided on the system on chip 150.

In at least one embodiment, the audio device 130 may include logic that is at least partially comprising hardware logic. The logic may receive first audio signals and provide an audio input flow. The logic may further receive second audio signals and provide an audio output flow. Logic may also align the audio input flow relative to the audio output flow.

In at least one embodiment, the audio device 130 may include software to be executed by hardware to perform operations, such as receive first audio signals and provide an audio input flow, receive second audio signals and provide an audio output flow, and align the audio input flow relative to the audio output flow.

The processor 170 may include a plurality of cores, such as a first core 176 and a second core 178. Each core may separately perform any one of various operations. Each of the cores may be separately called a processing entity.

The processor 170 may also include an interrupt handler 172 to handle interrupts 12, 22 from the audio input flow 10 and the audio output flow 20. The interrupt handler 172 may provide the interrupts 12, 22 (and/or additional data) to the respective cores 176, 178. As one example, the audio input flow 10 (and interrupts 12) may be provided to the first core 176, and the audio output flow 20 (and interrupts 22) may be provided to the second core 178.

The electronic device 100 may include a power management function. During the power management operation, the processor 170 may be provided into a sleep mode (or an idle mode) in which operations within the processor 170 are reduced to a minimum or even shut down. The processor 170 may be awakened from the sleep mode upon receipt of an interrupt at the interrupt handler 172. The processor 170 may then perform the necessary operations for the interrupt(s). After performing the necessary operations for the interrupt(s), the processor 170 may return to the sleep mode. The processor 170 may provide the corresponding audio input thread 30 and the corresponding audio output thread 40.

The audio device 130 may create the audio input flow 10 (and interrupts 12) based on signals received by the audio input device 110. The audio device 130 may also create the audio output flow 20 for the audio output device 120.

The audio device 130 may be a slave device that is not responsible for creation or destruction of data flows. The audio device 130 may respond to a device driver that runs on the cores that create the audio data flows, and the audio device 130 may respond to commands from the device drivers.

The audio device 130 may delay a first data flow that is created (or started) by the device driver, and the audio device 130 may align the first data flow with a second data flow.

In at least one embodiment, communication software that uses both the audio input flow 10 and the audio output flow 20 may be used to align the audio input flow 10 relative to the audio output flow 20. This may involve synchronizing the audio input flow 10 and the audio output flow 20. The communication software may be provided within the audio device 130 to align the interrupts 12 for the audio input flow 10 with the interrupts 22 for the audio output flow 20. This may align the audio input flow 10 relative to the audio output flow 20 such that they are synchronous with each other. Both the interrupts are aligned and the audio input/output flows 10, 20 are aligned since the audio flows are timed flows (i.e., isochronous).

As one example, the communication software may delay a start of the audio input flow 10 to be synchronized with a start of the audio output flow 20.

As another example, the communication software may delay a start of the audio output flow 20 to be synchronized with a start of the audio input flow 10.

The audio input flow 10 may be an isochronous flow. Additionally, the audio output flow 20 may be an isochronous flow. Therefore, once the audio input flow 10 is aligned relative to the audio output flow 20, the audio flows 10, 20 may remain aligned throughout their execution. After alignment, the interrupts 12 for the audio input flow 10 may occur at same times as the interrupts 12 for the audio output flow 22. Accordingly, a number of times that the processor 170 may be awakened may be reduced as compared to the non-aligned audio input flow and audio output flow.

Execution of the audio input thread 30 may be performed on one core, such as the first core 176, simultaneously with execution of the audio output thread 40 being performed on another core, such as the second core 178.

In at least one embodiment, hardware (or hardware logic) within the audio device 130 may align the audio input flow 10 relative to the audio output flow 20 when both the audio input flow 10 and the audio output flow 20 are being used.

In another example, the hardware (or hardware logic) may delay the audio input flow 10 to align with the audio output flow 20. In another example, the hardware may delay the audio output flow 20 to align with the audio input flow 10.

The device driver may request an input data flow or an output data flow to start (or be created). The audio device 130 may not respond, and may optionally start a timer that may start counting down. The timer may be provided within the audio device 130, for example.

The audio device 130 may wait until the timer counts down and if a new data flow in an opposite direction is started before the timer expires, then the audio device 130 may respond for both data flows at a same time and may initiate/create those on the audio device 130 at a same clock cycle.

If the timer expires and another data flow is not initiated, then the audio device 130 may start a single flow.

A method may now be described of hardware alignment of an audio input path and an audio output path according to an example embodiment. Other embodiments and operations may also be used.

In at least one embodiment, an audio input path (or audio input flow) may be enabled. An audio path being enabled may be a request to create an audio data path. Subsequently, a determination may be made regarding whether an audio output path (or audio input flow) is enabled.

If the determination is that the audio output path is not enabled, then the audio output path may be enabled. On the other hand, the determination is that the audio output path is enabled, then a start of the audio input path may be delayed. The delayed start of the audio input path may be aligned relative to the audio output path (as long as the delayed start does not exceed a start time requirement). After the alignment, the audio input path may be enabled.

In at least one embodiment, an audio output path may be enabled. Subsequently, a determination may be made regarding whether the audio input path is enabled.

If the determination is that the audio input path is not enabled, then the audio input path may be enabled.

On the other hand, if the determination is that the audio input path is enabled, then a start of the audio output path may be delayed. The delayed start of the audio output path may be aligned relative to the audio input path (as long as the delayed start does not exceed a start time requirement). After the alignment, the audio output path may be enabled.

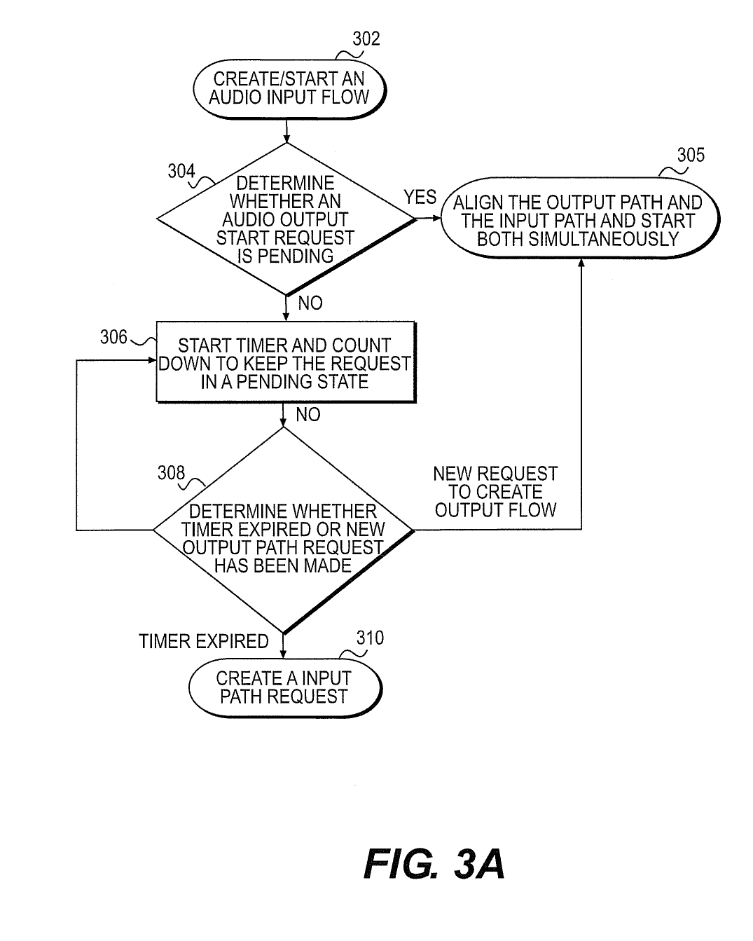

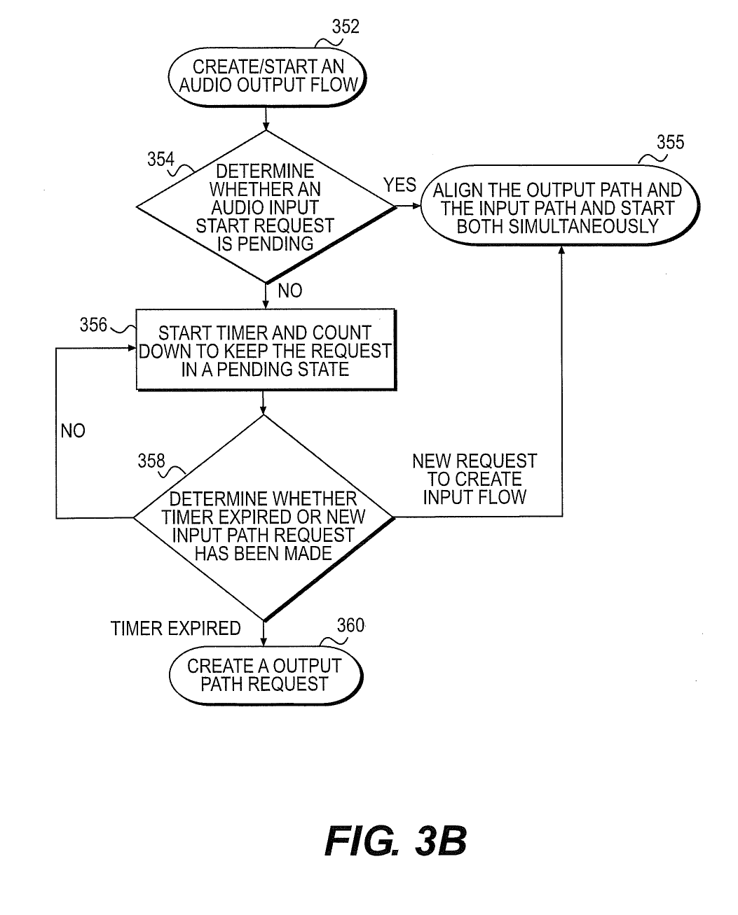

FIG. 3A is a flowchart showing alignment of an audio input flow and an audio output flow. FIG. 3A may relate to starting an input data flow to be issued to an audio device according to an example embodiment. Other embodiments and operations may also be provided.

More specifically, FIG. 3A shows an audio input flow is created (or started) in operation 302. A determination may be made in operation 304 whether an audio output path start request is pending in operation 304. If the output path start request path is pending (i.e., a Yes determination), then the output path and the input path may be aligned and started simultaneously in operation 305.

If the output path start request path is not pending in operation 304 (i.e., a No determination), then in operation 306 a timer may be started and counted down to keep the request in a pending state. In operation 308, a determination may be made whether the timer expired or a new output path request has been made.

If the timer is determined to not have expired in operation 308 (i.e., a No determination), then operation 306 is maintained. On the other hand, if it is determined that a new request is made to create an output flow, then the output path and the input path may be aligned and started simultaneously in operation 305.

On the other hand, if the timer is determined to have expired in operation 308 (i.e., a timer expired determination), then an input path request (or input flow request) may be created in operation 310. Operations may then proceed to operation 304.

FIG. 3B is a flowchart showing alignment of an audio input flow relative to an audio output flow. FIG. 3B may relate to starting an output data flow to be issued to an audio device according to an example embodiment. Other embodiments and operations may also be provided.

More specifically, FIG. 3B shows an audio output flow is created (or started) in operation 352. A determination may be made in operation 354 whether an audio input path start request is pending. If the input path start request path is pending in operation 354 (i.e., a Yes determination), then the output path and the input path may be aligned and started simultaneously in operation 355.

If the input path start request path is not pending in operation 354 (i.e., a No determination), then in operation 356 a timer may be started and counted down to keep the request in a pending state. In operation 358, a determination may be made whether the timer expired or a new input path request has been made.

If the timer is determined to not have expired in operation 358 (i.e., a No determination), then operation 356 is maintained. On the other hand, if it is determined that a new request is made to create an input flow, then the output path and the input path may be aligned and started simultaneously in operation 355.

On the other hand, if the timer is determined to have expired in operation 358 (i.e., a timer expired determination), then an output path request (or input flow request) may be created in operation 360. Operations may then proceed to operation 354.

The audio device 130 may perform operations based on software. The software may be provided on a machine readable medium having stored thereon a plurality of instructions executable by the electronic device 100. The software may perform various operations including determining that a first audio data flow of the electronic device is to be enabled, determining that a second audio data flow of the electronic device is to be enabled, and aligning the first audio data flow with the second audio data flow. The software may align a start of the first audio data flow relative to a start of the second audio data flow. The software may align interrupts for the first audio data flow with interrupts for the second audio data flow.

Embodiments may align an audio input flow relative to an audio output flow such that a host processor may awaken (from a sleep or idle mode) to service both audio input flow and audio output flow at a same time.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An apparatus for providing audio signals, comprising logic, the logic at least partially comprising hardware logic to:
receive first audio signals and provide an audio input flow;
receive second audio signals and provide an audio output flow; and
align the audio input flow relative to the audio output flow.

2. The apparatus of claim 1, wherein the logic to align the audio input flow relative to the audio output flow at substantially a same time.

3. The apparatus of claim 1, wherein the logic to align interrupts for the audio input flow with interrupts for the audio output flow.

4. The apparatus of claim 1, wherein the apparatus to use software to align the audio input flow relative to the audio output flow.

5. The apparatus of claim 1, wherein the apparatus includes hardware to align the audio input flow relative to the audio output flow.

6. The apparatus of claim 5, wherein the hardware to delay a start of the audio input flow to align the audio input flow relative to the audio output flow.

7. The apparatus of claim 5, wherein the hardware to delay a start of the audio output flow to align the audio input flow relative to the audio output flow.

8. An electronic device comprising:
an input device to provide first audio signals;
an output device to receive second audio signals; and
logic to receive the first audio signals and to provide an audio input flow, the logic to further receive an audio output flow and to provide the second audio signals to the output device based on the audio output flow, and the logic to align the audio input flow relative to the audio output flow.

9. The electronic device of claim 8, comprising a processor having a plurality of cores and an interrupt handler.

10. The electronic device of claim 9, wherein a first one of the plurality of cores to execute interrupt operations for the audio input flow, and a second one of the plurality of cores to execute interrupt operations for the audio output flow.

11. The electronic device of claim 10, wherein the logic to align interrupts for the audio input flow with interrupts for the audio output flow.

12. The electronic device of claim 8, wherein the logic to use software to align the audio input flow relative to the audio output flow.

13. The electronic device of claim 8, wherein the logic includes hardware to align the audio input flow and the audio output flow.

14. The electronic device of claim 13, wherein the hardware to delay a start of the audio input flow to align the audio input flow relative to the audio output flow.

15. The electronic device of claim 13, wherein the hardware to delay a start of the audio output flow to align the audio input flow relative to the audio output flow.

16. A machine readable medium having stored thereon a plurality of machine readable instructions executable by an electronic device to perform operations to:
detect a first audio data flow of the electronic device;
detect a second audio data flow of the electronic device; and
align the first audio data flow relative to the second audio data flow.

17. The machine readable medium of claim 16, the operations to further determine that the first audio data flow is to be enabled.

18. The machine readable medium of claim 17, the operations to further determine that the second audio data flow is to be enabled.

19. The machine readable medium of claim 18, the operations to align the first audio data flow relative to the second audio data flow when the first audio data flow is determined to be enabled while the second audio data flow is to be enabled.

20. The machine readable medium of claim 16, wherein to align the first audio data flow includes to align a start of the first audio data flow with a start of the second audio data flow.

21. The machine readable medium of claim 20, wherein the operations to further:
provide the start of the first audio data flow at a substantially same time as the start of the second audio data flow.

22. The machine readable medium of claim 16, wherein the first audio data flow is an audio input flow, and the second audio data flow is an audio output flow.

23. The machine readable medium of claim 16, wherein the second audio data flow is an audio output flow, and the first audio data flow is an audio input flow.

24. The machine readable medium of claim 16, wherein to align the first audio data flow with the second audio data flow includes to align interrupts for the first audio data flow with interrupts for the second audio data flow.
